(19) United States
(12) Patent Application Publication
(10) Pub. No.: US 2025/0313663 A1
(43) Pub. Date: Oct. 9, 2025

(54) HIGH SOLID, SELF-THICKENING COPOLYMER LATEX FOR SEALANT

(71) Applicant: Pidilite Industries Limited, Mumbai (IN)

(72) Inventors: Santanu Kumudranjan Roy, Mumbai (IN); Sandeep Vasant Magdum, Mumbai (IN); Rajesh Balaji Manave, Mumbai (IN)

(21) Appl. No.: 19/245,641

(22) Filed: Jun. 23, 2025

Related U.S. Application Data
(63) Continuation of application No. PCT/IB2023/061950, filed on Nov. 28, 2023.

(30) Foreign Application Priority Data
Dec. 28, 2022 (IN) 202221076155

(51) Int. Cl. C08G 63/00; C08G 10/00; C08G 12/22

(52) U.S. Cl. CPC C08G 63/00; C08G 10/00; C08G 12/22; C08G 2190/00

(57) ABSTRACT

A copolymer latex for sealant. The said composition may be used in various applications such as non-pigmented and pigmented sealants for gap filling, waterproofing, in construction and other applications. The copolymer latex composition includes an organic acid fraction, an amide derivative fraction, an acrylic monomer fraction, and a surfactant fraction. The copolymer latex composition may include at least 55% solids of polymerization product of one or more monomers. The said composition is such that the copolymer latex shows properties such as self-thickening ability and good water repellence. The said composition at dry film thickness of about 2 mm provides transparency. In addition, the copolymer latex provides properties like hydrophobicity, tensile strength, elongation efficiency, and low foaming.

### CROSS-REFERENCE TO RELATED APPLICATIONS AND PRIORITY

The present application claims priority from the PCT/IB2023/061950 filed Nov. 28, 2023 and Indian provisional patent application, having application No. 202221076155, filed on 28 Dec. 2022, incorporated herein by reference.

### TECHNICAL FIELD

The present disclosure is directed to a copolymer latex composition. More particularly, the present disclosure is directed to a copolymer latex composition for sealants.

### BACKGROUND

Many different industrial and household construction applications include the usage of sealants. The frequently used sealants are silicone, acrylic, urethane, butyl, and other polymeric types. Over the years, several formulations have been created that satisfy the performance requirements required by building standards, as well as the needs of the end-user. Sealants are known to be used for a variety of purposes including waterproofing, decorative purpose, aesthetics, and the like.

Generally, sealants are used to prevent liquids, water from passing through the surface joints or opening materials of window joints, door joints, etc. Sealants also provide thermal and acoustical insulation and have many electric-related applications. A sealant is formulated such that it can enter the substrate through capillary action, or a viscous substance depending on the application.

Sealants are generally composed of solids and solvent or water. The major role of solvent or water is to help in the uniform application of the sealant to the substrate. In some cases, the solvent does not dissolve the solid but dilutes or thins it. The solids used in this composition may be of different kinds such as binders, pigments, extenders and additives. In some cases, the percentage of solid defines the quality of sealant.

Surfaces such as concrete, brick, masonry, and stone are often protected against corrosion and general deterioration when gap-filling formulations are applied to them. Numerous sealants and repellents are known in the prior art, for instance, silicates, siloxanes, siliconates, vinyls, silicones, polyurethanes, and styrene-butadiene copolymers are some examples. They are either based on water, solvents, or a combination of both.

In state of the art, siliconate-based sealants are used as caulk/gap filling agents, however, when they react with carbon dioxide and carbonaceous matters present in the substrate and form a white or yellow coloured precipitate. This abnormal layer may become quite visible. Such a change in discolouration and appearance of the substrate after curing of siliconate waterproofing solution is generally not acceptable.

Further, high solid content has the effect of less evaporation during the drying process and makes the finish brighter and more compact, also less shrinkage ensues. High solids contents also give a better finish and require a short drying time due to less amount of solvent or water which is a continuous medium. Solvents used in sealants, adhesives, and coating contribute to VOC (volatile organic compounds) to a significant extent. Hence, the use of high solid content in water-based sealants minimizes the toxicity levels generated by VOC (volatile organic compounds) in the composition.

Viscosity is the resistance of fluids to change in shape or movement relative to one another. In the case of typical industrial products, the viscosity remains low for solid volume contents up to 50% in most of the cases. However, above specific limit, the viscosity can increase extremely rapidly as a function of solids content and design aspect of polymer, if special care is not taken in its formulation; the latex becomes highly viscous resulting in non-uniform film formation upon drying.

Further, the thickening property is also desired during a sealant formulation. The thickening of the latex is defined based on the viscosity of the polymer used and the rheology modifier. The externally added rheology modifiers can affect the transparency of the latex, as refractive index may differ affecting the clarity upon drying. The externally added thickener can also result in low repeatability and reproducibility of viscosity, inadequate dispersibility and thus application rheology. This will cause sealant to be not of optimum performance.

Besides, the obtained sealant containing external rheology modifier or thickener can lead to poor storage stability and water resistance. Hence, it is challenging to come up with a water-based formulation which is hydrophobic, fast curing, self-thickening and has an appropriate viscosity.

The thickness of the sealant formulation which are applied to the substrates depends on the solid content of the formulation. Low solids formulations are easier to apply but have the disadvantage that it forms a thin dry film. Hence, a sealant which gives a better thickness after application is a requirement which is achieved with high solid content polymer dispersion in water or solution in solvent.

In state of the art, U.S. Pat. No. 5,744,544 discloses a method for polymerizing at least one unsaturated monomer in the presence of a latex results in a high solids dispersion of polymer particles with lower viscosities. The preferred use is in acrylate water-based caulking compounds. However, the said latex does not provide the properties such as, stability on ageing and at higher temperature, water resistance, and clarity/transparency upon drying.

In state of the art, European patent Application 3838936 discloses about curable composition which comprises (meth)acrylic monomers, ethylenically unsaturated oligomers and a specific multistage additive. The additive is used as a processing aid to reduce cure shrinkage and prevent the formation of cracks during the polymerization of the composition during application. However, the patent is not focused on thickening efficiency of the compositions, water resistance, and transparency of the composition.

In state of the art, European patent Application 3385350 discloses a polymeric dispersion relating to uses in adhesives or sealants improving the stability of aqueous polymer dispersion and does not disclose features such as water resistance and aesthetic requirement of transparency particularly in case of caulk and sealant applications for the surfaces such as metal, stone, concrete, and masonry.

Since sealants are intended to block fluid flow and are frequently used for waterproofing, the polymer's hydrophobicity is important specification necessity. Tensile strength and elongation of sealants based on copolymer latex is a further critical need in addition to the previously listed characteristics.

The adhesive sealants ability to withstand deformation is reflected or can be correlated in the tensile strength. Therefore, in addition, self-thickening ability, providing transparency on drying to a sealant composition, hydrophobicity, wettability and meeting all other stated properties an appropriate gap filling has been difficult to achieve.

Despite the research attempts in developing the copolymer dispersions in various application, there is still a long-standing need of addressing the challenges by delivering a hydrophobic sealant comprising a high-solid, self-thickening, copolymer latex composition which also provides transparency on drying.

### SUMMARY

This summary is not intended to disclose essential features of the invention, nor it is intended to determine, limit or restrict the scope of the invention.

Disclosed is a copolymer latex composition for sealant and adhesive. The copolymer latex composition of the present disclosure exhibits excellent tensile strength, self-thickening properties, hydrophobicity, transparency of dry-film, high viscosity, and various applications, such as construction, waterproofing as various substrate-based sealants.

In one embodiment of the present invention, a copolymer latex composition is disclosed. The copolymer latex may comprise at least 55% solids of polymerization product of one or more monomers. The one or more monomers may comprise an acrylic monomer fraction, organic acid fraction, an amide derivative fraction, and a surfactant fraction. The stated surfactant fraction may be in a range of at least 0.4% based on total monomer quantity. The viscosity of the copolymer latex composition may be in the range of 2 to 50 poise at an acidic pH. The self-thickening efficiency of the copolymer latex composition in terms of viscosity rise may be >1500 poise and specifically 1500-2000 poise at an alkaline pH.

In one embodiment, a sealant composition comprising a copolymer latex composition in disclosed. The sealant composition, wherein the copolymer latex may comprise an acrylic monomer fraction, organic acid fraction, an amide derivative fraction, and a surfactant fraction. The stated surfactant fraction may be in a range of at least 0.4% based on total monomer quantity. The viscosity of the copolymer latex composition may be in the range of 2 to 50 poise at an acidic pH. The self-thickening efficiency of the copolymer latex composition in terms of viscosity rise may be 1500-2000 poise at an alkaline pH. The sealant composition may further comprise one or more additives such as wetting agents, a coalescing agent, a silane coupling agent, anti-sag agent, neutralizer, and a rheology modifier.

Other features and advantages of the present invention will be apparent from the following detailed description of the invention which illustrates, by way of example, the principles of the invention.

### BRIEF DESCRIPTION OF DRAWINGS

The detailed description is described with reference to the accompanying figures. In the Figures, the left-most digit(s) of a reference number identifies the figure in which the reference number first appears. The same numbers are used throughout the drawings to refer like features and components.

FIG. 1 illustrates a contact angle measurement test results for copolymer latex composition, in accordance with an embodiment of the present invention.

FIG. 2 illustrates foaming test results for copolymer latex before shaking the copolymer latex composition in form of emulsion, in accordance with an embodiment of the present invention.

FIG. 3 illustrates foaming test results for copolymer latex immediately after 20 shakes to the copolymer latex composition in form of emulsion (t=0 mins), in accordance with an embodiment of the present invention.

FIG. 4 illustrates foaming test results for copolymer latex after 5 mins of shaking the copolymer latex composition in form of emulsion, in accordance with an embodiment of the present invention.

FIG. 5 illustrates thick film of copolymer latex composition before dipping the film in water, in accordance with an embodiment of the present invention.

FIG. 6 illustrates thick film of copolymer latex composition after 24 hours dipping the film in water, in accordance with an embodiment of the present invention.

FIG. 7 illustrates thick film of copolymer latex composition after 48 hours dipping the film in water, in accordance with an embodiment of the present invention.

FIG. 8 illustrates thick film of copolymer latex composition after 7 days (168 hours) dipping the film in water, in accordance with an embodiment of the present invention.

### DETAILED DESCRIPTION

Reference throughout the specification to various embodiments, some embodiments, one embodiment, or an embodiment means that a particular feature, structure, or characteristic described in connection with the embodiment is included in at least one embodiment. Thus, appearances of the phrases in various embodiments, in some embodiments, in one embodiment, or in an embodiment in places throughout the specification are not necessarily all referring to the same embodiment. Furthermore, the particular features, structures or characteristics may be combined in any suitable manner in one or more embodiments.

The words “comprising”, “having”, “containing”, and “including”, and other forms thereof are intended to be equivalent in meaning and be open-ended in that an item or items following any one of these words is not meant to be exhaustive listing of such item or items or meant to be limited to only the listed item or items.

It must also be noted that the singular forms “a”, “an”, and “the” include plural references unless the context clearly dictates otherwise. Although any methods similar or equivalent to those described herein may be used in the practice or testing of embodiments of the present disclosure, the exemplary methods are described.

The disclosed embodiments are merely exemplary of the disclosure, which may be embodied in various forms. Various modifications to the embodiment may be readily apparent to those skilled in the art, and the generic principles herein may be applied to other embodiments. However, one of ordinary skill in the art may readily recognize that the present disclosure is not intended to be limited to the embodiments illustrated but is to be accorded the widest scope consistent with the principles and features described herein. The detailed description of the invention will be described hereinafter referring to accompanied drawings.

The present invention intends to disclose a copolymer latex composition for a sealant composition and a sealant composition used for a variety of applications such as, gap filling, waterproofing or aesthetic purposes. The copolymer latex can be used as a polymer dispersion, or a binder.

The disclosed copolymer latex composition may comprise components acting as a binder and capable of being polymerized and crosslinked and comprising one or more monomers. In one embodiment, the copolymer latex composition may comprise at least 55% solids of polymerization product of one or more monomers. In one embodiment, the one or more monomers in copolymer latex composition may comprise an organic acid fraction, an amide derivative fraction, acrylic monomer fraction and a surfactant fraction.

In one embodiment, the said copolymer latex comprises of polymerization product of an acrylic monomer fraction. The stated acrylic monomer fraction is preferably a (meth)acrylic monomer. The (meth)acrylic monomer may further comprise at least one of methyl acrylate (MA), butyl acrylate (BA), ethyl acrylate (EA), methyl methacrylate (MMA), styrene, 2-ethyl hexyl acrylate (2-EHA), hexyl acrylate, octyl acrylate, tert. butyl acrylate (t-BA), stearyl acrylate, n-butyl methacrylate, iso-butyl methacrylate, hexyl methacrylate, octyl methacrylate, iso-bornyl acrylate, glycidyl acrylate, phenyl acrylate, 2-hydroxyl ethyl acrylate (2-HEA), 2-hydroxyl ethyl methacrylate (2-HEMA), cyclohexyl methacrylate (CHMA), stearyl methacrylate, iso-bornyl methacrylate, glycidyl methacrylate, phenyl methacrylate etc. (meth)acrylate monomers are usually easter which contain vinyl groups. the (meth)acrylic monomers can impart properties such as transparency, resistance to breakage, elasticity, versatility, strength, and ensure workability in harsh weather. The said (meth)acrylic monomer fraction is preferably at least 65% based on total monomer and more preferably at least 75% based on total monomer quantity.

In another related embodiment, the said copolymer latex comprises amide derivative. The stated amide derivative may comprise but not limited to acrylamide, methacrylamide, n-methyl acrylamide, n-ethyl acrylamide, n-propyl acrylamide, n-isopropyl acrylamide, n-butyl acrylamide, n-methyl methacrylamide, n-ethyl methacrylamide, n-propyl methacrylamide, n-isopropyl methacrylamide, n-butyl methacrylamide etc. Preferably, the stated amide derivatives may be selected from at least one of acrylamide, and methacrylamide. The amide derivatives are incorporated in copolymer latex to improve mechanical properties of the copolymer latex and may impart better adhesion. The stated amide derivative is in a range of at least 0.1 to 5% based on total monomer quantity.

In another related embodiment, certain monomer species are added to the latex to increase its hydrophobicity. The invention relates to a copolymer latex which further may comprise vinyl monomer such as styrene. Styrene is a clear, colourless to yellow hydrophobic liquid, with a distinct odour.

In a related embodiment, the invention relates to a copolymer latex composition wherein the stated organic acid fraction comprises at least one of but not limited to methacrylic acid, acrylic acid, vinyl formic acid, itaconic acid, fumaric acid, crotonic acid, acrylamido-2-methylpropanesulfonic acid (AMPS), maleic acid, and aconitic acid. The said polymer latex may comprise organic acid which can be used alone or a combination of two of abovementioned organic acids. More preferably, the organic acid may comprise methacrylic acid and acrylic acid. Further, the stated organic acid fraction is in a range of at least 0.1 to 5% based on total monomer quantity.

In another embodiment, the invention relates to a copolymer latex wherein the viscosity of the said copolymer latex is in the range of 2 to 50 poise at an acidic pH 4.5-5.8. In a preferred embodiment, the viscosity of the copolymer latex composition is between 5-30 poise. However, the viscosity rises to more than 1500 poise at alkaline pH 8.8-9.8 and preferably between 1500-200. This high viscosity of the copolymer latex achieved under alkaline condition is related with the high self-thickening efficiency of the said copolymer latex (due to alkali swellable emulsion (ASE) type thickening mechanism). The advantage of self-thickening characteristic is requirement of reduced dosage of rheology modifier for the sealant formulator which helps further in film transparency/clarity and retention of high hydrophobic character.

In another related embodiment, the said copolymer latex composition may further comprise a surfactant fraction. The said surfactant fraction may comprise at least one of a combination of anionic surfactant, anionic reactive surfactant, and non-ionic surfactant. The said surfactant moiety may be reactive or non-reactive. Surfactant moieties are important for use as emulsifying/stabilizing agent, wetting agent, and/or dispersing agent. The said surfactant moiety as incorporated herein shows less foaming, thereby indicating that surfactant present in the polymer backbone is reacting with main polymer backbone and thus non-leaching. In a preferred embodiment, the said surfactant moiety is a reactive surfactant having a polymerizable surfactant property. The surfactant moiety is preferably an anionic or non-anionic, co-polymerizable surfactant. The stated surfactant fraction is in a range of at least 0.4 parts by 100 parts of total monomer quantity. In a preferred embodiment, the polymer latex comprises a reactive surfactant fraction.

The said reactive surfactant fractions provides superior colloidal stability to the latex. The reactive surfactant fraction incorporated in the polymer latex is selected from but not limited to modified fatty alcohol ether phosphates, polyoxyethylene (allyloxymethyl) alkyl ether sulphates or polyoxyethylene styrenated propenyl phenyl ether sulphates, and alkyl allyl sulfosuccinates.

The said reactive surfactant fraction may be selected from a plurality of available commercial products selected from at least one of but not limited to Maxemul 6106, Maxemul 6112 (Croda), Adeka Reasoap SR 10, Adeka Reasoap SR 20, Adeka Reasoap SR 3025 (Adeka), Reactsurf 2490, Reactsurf S8115 (Solvay), Hitenol KH 05, Hitenol KH 10 (Dai-Ichi Kogyo Seiyaku), Emulsogen CPS 100 XS (Clariant).

In another embodiment, anionic surfactants (non-reactive) may be selected from a plurality of available commercial products selected from at least one of but not limited to the surfactants such as Rhodacal LSS 40 M/RL, Rhodapon LX 28/RL, Rhodapex ESB 28/RB, Rhodapex LA 300/SB, Rhodacal DS4-AP, Rhodafac RS-610 A25, Aerosol EF 800, Aerosol EF 810 (Solvay), Disponil FES 27, Disponil FES 32, Disponil FES 77 (BASF), Calfax DB-45, Calfax 16 L35 (Pilot Chemical), Emulsogen EPA 073 (Clariant), Dowfax AS-801 (Dow) etc.

In yet another embodiment, the non-ionic surfactants (non-reactive) may be selected from a plurality of available commercial products selected from at least one of but not limited to Rhodoline WA 40 (Solvay), Disponil AFX 3070, Disponil A 4065 (BASF), Emulsogen LCN 287, Emulsogen LCN 407 (Clariant), Atsurf G120/70, Atpol 5731/70N (Croda), Berol EP 25 (Akzo-Nobel), Tergitol 15 S/40 (Dow) etc.

In yet another embodiment, the self-thickening efficiency of the copolymer latex composition in terms of viscosity rise is between 1500-2000 poise at an alkaline pH. In an exemplary embodiment, the said copolymer latex has a total solid content of at least 55% w/w or more preferably, in the range of 55-71% w/w.

In one embodiment, during polymerization of one or more monomers as disclosed, initiator(s) are used. Examples of suitable initiators include potassium peroxy-disulphate (potassium persulphate), sodium peroxy-disulphate (sodium persulphate), ammonium peroxy-disulphate (ammonium persulphate), organic peroxides, organic hydroperoxides and tertiary butyl hydroperoxide. In one embodiment, potassium persulphate is preferably used. The initiator is suitably used in the range of 0.1% to 3% based on total weight of the monomers.

The polymerization can be carried out using known method for preparing aqueous emulsion polymerization. The polymerization reaction to obtain the copolymer latex is generally conducted at temperatures of 45° C. to 95° C., preferably at 55-95° C. and more preferably 65-95° C.

Under acidic conditions, the copolymer particles in the latex composition have closed, coil-like structure and after the addition of alkali into it, the pH increases, and the copolymer starts to uncoil. As the pH increases further, the increased surface area of the copolymer results in reduced free water availability, which results in enhanced viscosity of the copolymer latex.

In one embodiment of the present disclosure, a process for obtaining a copolymer latex composition is disclosed. The said process may comprise preparing copolymer latex comprising of mixing of external seed of pre-formed polymer with monomer pre-emulsion, radical forming initiator solution, and sodium bicarbonate buffer solution. The first stage of process may further comprise heating the formed copolymer latex at 88° C. for 15 minutes. In the next step simultaneous addition of monomer pre-emulsion with a continuous addition of a radical forming initiator solution is carried out. In the next step, the copolymer latex composition is cooled to 70° C. with simultaneous addition of chaser-catalyst compounds. In the later stage of the process, further cooling to less than 45° C. followed by addition of preservatives and defoamer is performed. In one embodiment, the external seed may be formed from monomer pre-emulsion and radical forming initiator solution. The said external seed is prepared by the process of emulsion polymerization. The external seed is a copolymer of acrylate & methacrylate ester monomers and is of 35% solids content and having average particle size of about 90-110 nm.

In a related embodiment, the said monomer pre-emulsion comprises of an organic acid fraction, an amide derivative, acrylic monomer fraction, and a surfactant fraction in accordance with the embodiments of the present disclosure.

In one embodiment, the chaser-catalyst compound comprises at least one of oxidizing agents such as tertiary butyl hydroperoxide, hydrogen peroxide, cumene hydroperoxide and reducing agents such as sodium metabisulphite, ascorbic acid, bruggolite FF 6M (Bruggemann Chemical), sodium hydrosulphite etc. It was observed that certain specific chaser catalyst combinations are surprisingly efficient in reducing residual monomer concentration.

In one embodiment, the preservative is acticide SPX preservative. acticide SPX is a microbicide is used to control the growth of bacteria and fungi in water-soluble and water dispersed adhesives. Other suitable preservatives may be selected from a plurality of available commercial products selected from at least one of but not limited to Preventol D7, Preventol BM 10 (Lanxess), Rocima MBX, Rocima MB 2X (Dow), Parmetol MBX (Schulke), Thor MV, and Thor MBS 5050 (Thor).

In a related embodiment, the said copolymer latex composition can also be used in waterproofing applications such as waterproofing membranes (1K and 2K), in interior & exterior paints & coatings, in coating for textile fabrics & in pigment printing paste in textile fabrics, in fabric glues and in traffic marking coatings. The said copolymer latex composition can also be used in wood protection formulations and in wood coatings.

In one embodiment, the present disclosure relates to a sealant composition comprising a copolymer latex composition preferably used in the construction applications such as masonry, window sealants, door sealant formulations, electronic fitting, to prevent fluids and other substances from passing through material surfaces, joints, or openings. The sealants can also prevent passage of air, moisture, dust, sound, insects, thermal resistance, fire-proofing, etc.

In yet another embodiment of the present disclosure, a sealant composition comprising a copolymer latex composition is disclosed. The sealant composition may comprise an organic acid fraction, an amide derivative, acrylic monomer fraction, and a surfactant fraction in a range of at least 0.4% based on total monomer quantity, and one or more additives such as wetting agents, a coalescing agent, a silane coupling agent, anti-sag agent, neutralizer, and a rheology modifier.

In one example, wetting agent is selected as Rhodoline WA 40 (Solvay). In another example, the coalescing agent is selected as butyl carbitol (Dow). In yet another example, silane coupling agent is selected as Silquest A-1100 (Momentive), anti-sag agent is selected as fumed Silica, rheology modifier selected as Rheolate 278 (Elementis). In one embodiment, the copolymer latex in accordance with embodiment of the present disclosure reduces the requirement of external addition of rheology modifier while preparing a sealant. The Less amount of rheology modifier is sufficient as the copolymer latex is self-thickening and the higher amounts of external rheology modifiers affects the transparency of the sealant on drying.

The said copolymer latex of the sealant composition is having a solid content of at least 55% wherein a viscosity of the copolymer latex composition is between 2-50 and preferably 5-30 poise at an acidic pH, and wherein a self-thickening efficiency of the copolymer latex composition in terms of viscosity rise is viscosity rises to 1500-2000 poise at an alkaline pH.

The application of the sealant is related to properties such as dry film thickness. Dry film thickness (DFT) is the thickness of a coating as measured above the substrate. This can consist of a single layer or multiple layers. DFT is measured for cured coatings. In one embodiment, the said copolymer latex when casted has a dry film thickness (DFT) of about 1-10 mm, preferably 1-5 mm, and more preferably about 1-3 mm. Due to the high solid content, the copolymer latex may be cast on any substrate surface, including wood, aluminium, marble, granite, and glazed tiles, and a single layer may have a thickness of roughly 2 mm.

In one embodiment, the invention relates to a copolymer latex to be used in sealant compositions, wherein the copolymer latex possesses superior durability, reduced water absorption, hydrophobicity, self-thickening ability, weathering resistance, stability, and transparency on drying gauged by various evaluation systems. In one embodiment, the sealant composition comprising the copolymer latex provides clarity of dried 2 mm film of non-pigmented copolymer latex as clear and transparent. In a related embodiment, wherein the said sealant composition can also be used to formulate a pigmented sealant.

Also, if any specific pigment is added to the sealant, then the said sealant composition may provide a pigmented appearance, however, the copolymer latex present in the sealant composition will not affect the transparency of the sealant.

In one embodiment, the said copolymer latex film shows water absorption of less than 15% after dipping in water for 24 hours and more preferably less than 10% after dipping in water for 24 hours, which suggest that the said composition is mostly water repellant and highly hydrophobic.

In another embodiment, the said copolymer latex film provides clarity of dried 2 mm film of copolymer latex as clear and transparent.

In one embodiment, the said copolymer latex may contain average particle size ranging from 50 to 500 nm and more specifically may contain average particle size ranging from 200 to 500 nm. The polymer particle size may be evaluated by the Brookhaven particle size analyzer using the principle of dynamic light scattering. The size of particles play an important role in obtaining high solid latex and in determination of hardness, resistance to weathering, durability, enhanced mechanical strength and abrasion resistance.

In another related embodiment, the copolymer latex may have weight average molecular weight in the range of 140000 to 280000 measured using Gel Permeation Chromatography (GPC) instrument Malvern Viscotek GPCmax. The weight average molecular weight of the copolymer latex in the range of 140000 to 280000 helps to achieve a balance of tensile strength, elongation, and flexibility.

In one embodiment, the said copolymer latex may possess a glass transition temperature (Tg) measured by Differential scanning calorimetry (DSC) in the range of −10° C. to 50° C. and more specifically in the range of −10° C. to 15° C. Glass transition temperature, or Tg is the temperature range at which a polymer changes from being a hard, glassy substance to a soft, rubber-like substance. The Tg is one of the most crucial characteristics of any latex, and it is especially significant for the stability, toughness, homogeneity in film formation and ease of application of copolymer latex composition-based sealants that may be used in a variety of applications. For the sealant formulation, high tack is not desired as it may attract more dirt/dust. Hence more preferably the copolymer latex comprises of Tg (DSC) between −5 to 12° C.

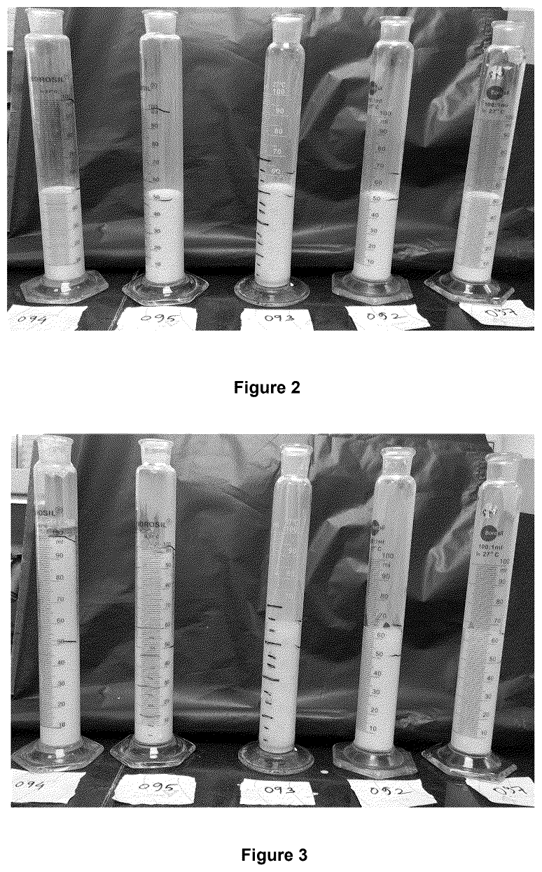

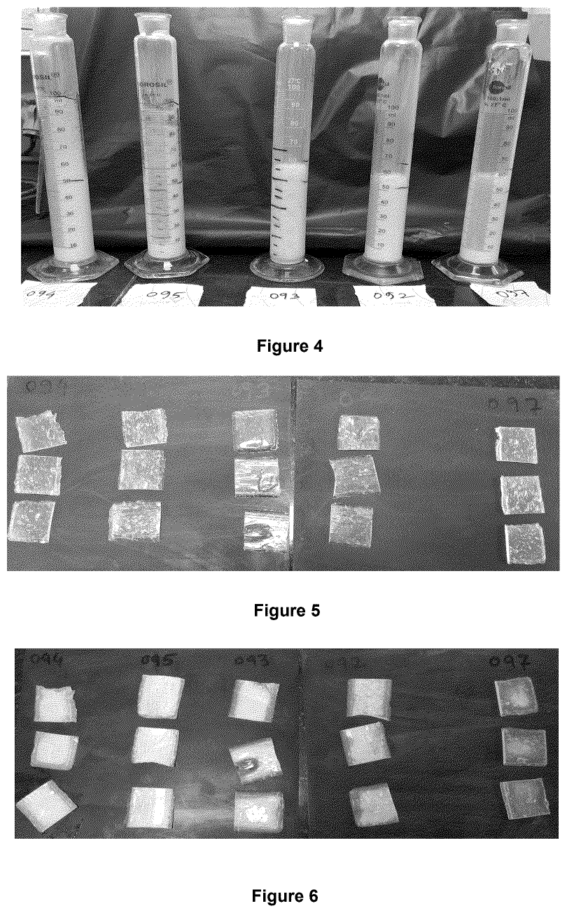

Referring to FIGS. 2, 3 and 4, one embodiment of the invention discloses that the foaming in the said copolymer latex is lesser as compared with the copolymer latex-synthesized by the conventional products.

In one embodiment, the invention relates to a copolymer latex composition wherein the said copolymer latex composition may possess self-thickening, high viscosity, transparency, hydrophobicity, less foaming, tensile strength, elongation, and other such characteristics as gauged by various standard evaluation systems.

### Water Absorption Test

One of such characteristics is the Water Absorption Test (ASTM C1016-14). This test method covers a laboratory procedure for determining the water absorption characteristics of sealant backing and joint filler materials.

### Test for Tensile Strength and Elongation

Another standard test for evaluating the tensile strength and elongation is the ASTM D412. These test methods cover procedures used to evaluate the tensile (tension) properties and elongation properties of materials. Another test for evaluating the adhesive characteristics of copolymer latex were carried out. This test involved the peel off adhesion of wet and dry copolymer latex layer on variety of substrates.

In one embodiment, following test method were also implemented.

### Peel Off Adhesion Test

To perform the peel off adhesion test of sealants based on the copolymer latex following steps are followed. Clean the substrate under test by wiping with cloth wet with Methyl Ethyl Ketone (MEK). Cast 120 mm×25 mm×3 mm wet film of sealant on the substrate under test. Allow it to cure for 7 days at ambient temperature. Then test the adhesion as follows:

### Dry Adhesion

Pull the dried film manually from one end and check cohesion. It should have cohesion failure.

### Wet Adhesion

Place the substrate with dry sealant film in water-in submerged condition. Remove from water after 24 hours, wipe out excess water with a cloth. Pull the sealant film manually from one end and check cohesion.

### Transparency

Cast 120 mm×25 mm×3 mm wet film of sealant on Teflon sheet. Allow it to cure for 7 days at ambient temperature. Observe visually for clarity/transparency and give comparative rating—10 being best and 0 being worst.

### Water Absorption Test of Sealant:

Cast 120 mm×25 mm×3 mm wet film of sealant on Teflon sheet. Allow it to cure for 7 days at ambient temperature. Cut it into three pieces of about 40 mm×25 mm area and then weigh each piece of dry film accurately using an analytical balance with least count of 1 mg. Note the weight as W1. Dip the pieces in about 400 ml water taken in 500 ml glass beaker, the pieces to remain submerged in water for 24 hours. Then remove each piece and gently wipe surface using tissue paper and weigh on the same balance mentioned above. Note the weight as W2. Calculate water absorption percentage using formula (W2−W1)×100/W1.

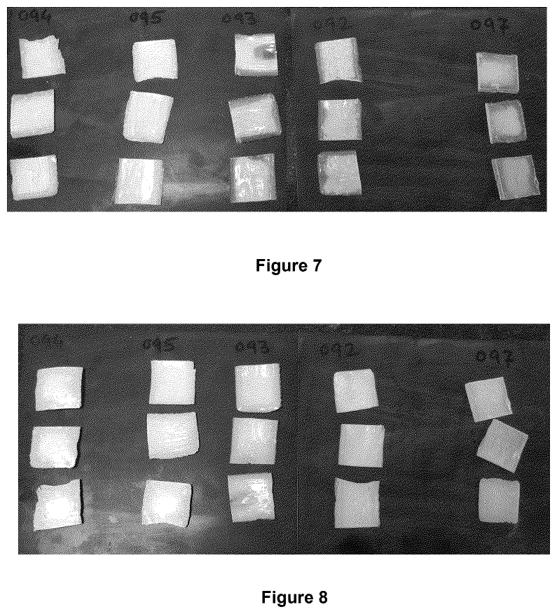

Referring to FIGS. 5, 6, 7 and 8 in one embodiment, the said copolymer latex provides water absorption by dipping the copolymer latex film in water for 24 hours, 48 hours, 96 hours up to maximum 15%. This test suggests that the copolymer latex is water repellent or hydrophobic.

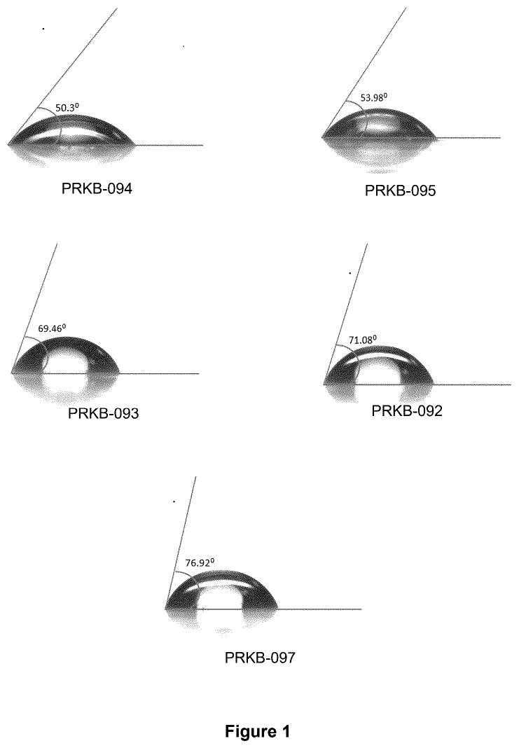

Further, referring to FIG. 1, a hydrophobicity correlation is carried out using contact angle determination is disclosed.

In another related embodiment, the copolymer latex provides a tensile strength (ASTM D412) in the range of 0.98 to 1.28 MPa. The said copolymer latex composition has balanced tensile strength and elongation, which are important parameters for performance of any sealant. These are critical requirements for the final performance of the sealant.

The following examples of the various embodiments may reveal a deeper understanding of the various properties of the copolymer latex composition to be used in various applications:

### EXAMPLES

### Example 1: Preparation of a Copolymer Latex with Conventional (Non-Reactive) Surfactant [Ref. No. PRKB-094]

Procedure: To 150 g of demineralized water, 35 g of external acrylic co-polymer seed latex was added to a reactor. 2 g of Sodium Bicarbonate was dissolved in 50 g of Demineralized water and added to the reactor. The contents were heated to 88° C. Then 30 g of 4% solution of potassium persulphate in demineralized water was added to reactor. Further, the following two feeds were added to the reactor: 1) Monomer mix pre-emulsion as mentioned in Table 1A and 2) 100 g of 4% solution of Potassium Persulphate in demineralized water.

TABLE 1 A

| Ingredient | Weight in grams |
|---|---|
| Demineralized water | 325 |
| Anionic surfactant (28-30% active) | 33 |
| Non-ionic surfactant (70% active) | 3.5 |
| Butyl Acrylate | 586 |
| Methyl Methacrylate | 330 |
| Ethyl Acrylate | 146 |
| Styrene | 120 |
| Methacrylamide | 10 |
| Methacrylic Acid | 10 |
| Acrylic Acid | 10 |

At the end of feed of monomer mix pre-emulsion and initiator solution, the contents of the reactor were held at 88° C. for 1 hour, then cooled to 70° C. and then tertiary butyl hydroperoxide solution in demineralized water was added simultaneously with a solution of sodium metabisulphite in demineralized water for 1 hour. Then, the batch was held as such for about 1 hour. Further, the copolymer latex was cooled below 40° C. and a solution of preservative in demineralized water was added to the copolymer latex for in-can preservation. Then a dispersion of defoamer mixed with demineralized water is added to the copolymer latex for foam control.

The resulting copolymer latex has the following properties contained in Table 1B.

TABLE 1B

| Parameters | Value | |
|---|---|---|
| Appearance | Bluish milky white | |
| Total Solid Content (w/w) | 62.7% | |
| pH (as such) | 5.5 | |
| Viscosity in poise | 180 | |
| (Brookfield RVT viscometer, 20 RPM, 30° C.) | | |
| Clarity of dried film on glass plate, cast using steel | Clear | |
| applicator of 150 microns | | |
| Avg. Particle Size (diameter) | 210 | nm |
| Molecular Weight of the Polymer (Mw) | 143,636 | |
| Glass Transition Temperature (Tg), DSC | 10° | C. |
| % Free monomer (GC) | 0.08% | |
| Contact Angle | 50.30° | |
| Foam Height at t = 0 minutes | >50 | ml |
| Foam Height at t = 5 minutes | 50 | ml |

| | |
|---|---|
| Acc stability test, oven (55° C./15 days) | Stable, No |
| | separation/ |
| | syneresis |

500 g of copolymer latex was neutralized with addition of 20% liquor ammonia solution to pH of 9.3±0.5, under constant stirring using high speed disperser. The thickened latex was allowed to stabilize for 2 hours. The viscosity post thickening was checked using Brookfield RVT viscometer, and thick film of latex was cast using a steel applicator of 3000 microns. The film was dried for 7 days at ambient temperature. 1 square inch pieces were cut and dipped in water to determine water absorption. The readings were taken after 24 hours, 48 hours, 96 hours and 168 hours. The test was carried out in triplicate and average of three readings was considered. While taking the reading, the film was removed from water, excess water was removed through wiping by tissue paper; weighing of copolymer latex film was carried out using a balance with 1 mg least count. The results are mentioned in Table 1C.

TABLE 1C

| Parameters | Value |
|---|---|
| pH after thickening with liquid ammonia | 9.6 |
| Thickening Viscosity in poise | 1600 |
| Clarity of the thick film after drying for 7 days | Clear |
| Clarity rating against clear transparent glass plate | 9 |
| [1 = poor (opaque) and 10 = best (transparent)] | |
| Water absorption, dipping - 24 hours (1 day) | 17.2% |
| Water absorption, dipping - 48 hours (2 days) | 27.1% |
| Water absorption, dipping - 96 hours (4 days) | 39.8% |
| Water absorption, dipping - 168 hours (7 days) | 48.3% |

### Example 2: Preparation of a Copolymer Latex with Conventional (Non-Reactive) Surfactant [Ref. No. PRKB-095]

Procedure: To 150 g of demineralized water, 35 g of external acrylic co-polymer seed latex was added in a reactor. 2 g of sodium bicarbonate was dissolved in 50 g of demineralized water and added to the reactor. The contents were heated to 88° C. Then 30 g of 4% solution of potassium persulphate in demineralized water was added to reactor. Monomer mix pre-emulsion as mentioned in Table 2A1 was added in 2.5 hours followed by Monomer mix pre-emulsion as mentioned in Table 2A2. Second separate and simultaneous feed of 100 g of 4% solution of Potassium Persulphate in demineralized water was added.

TABLE 2A1

| Ingredient | Weight in grams |
|---|---|
| Demineralized water | 220 |
| Anionic surfactant (28-30% active) | 22 |
| Non-ionic surfactant (70% active) | 2.35 |
| Butyl Acrylate | 352 |
| Methyl Methacrylate | 158 |
| Ethyl Acrylate | 146 |
| Styrene | 120 |
| Methacrylamide | 10 |
| Methacrylic Acid | 10 |
| Acrylic Acid | 10 |

TABLE 2A2

| Ingredient | Weight in grams |
|---|---|
| Demineralized water | 105 |
| Anionic surfactant (28-30% active) | 11 |
| Non-ionic surfactant (70% active) | 1.15 |
| Butyl Acrylate | 234 |
| Methyl Methacrylate | 172 |

At the end of feed of monomer mix pre-emulsion and initiator solution, the contents of the reactor were held at 88° C. for 1 hour, then cooled to 70° C. and then tertiary butyl hydroperoxide solution in demineralized water was added simultaneously with a solution of sodium metabisulphite in demineralized water for 1 hour. Then, the batch was held as such for about 1 hour. Further, the copolymer latex was cooled below 40° C. and a solution of preservative in demineralized water was added to the copolymer latex for in-can preservation. Then a dispersion of defoamer mixed with demineralized water is added to the copolymer latex for foam control.

The resulting copolymer latex has the following properties contained in Table 2B.

TABLE 2B

| Parameters | Value | |
|---|---|---|
| Appearance | Milky white | |
| Total Solid Content (w/w) | 62.9% | |
| pH (as such) | 5.5 | |
| Viscosity in poise | 6 | |
| (Brookfield RVT viscometer, 20 RPM, 30° C.) | | |
| Clarity of dried film on glass plate, cast using steel | Clear | |
| applicator of 150 microns | | |
| Avg. Particle Size (diameter) | 295 | nm |
| Molecular Weight of the Polymer (Mw) | 251,155 | |
| Glass Transition Temperature (Tg), DSC | 12° | C. |
| % Free monomer (GC) | 0.03% | |
| Contact Angle | 53.98° | |
| Foam Height at t = 0 minutes | 50 | ml |
| Foam Height at t = 5 minutes | 45 | ml |

| | |
|---|---|
| Acc stability test, oven (55° C./15 days) | Stable, No |
| | separation/ |
| | syneresis |

The resulting copolymer latex showed self-thickening ability. 500 g of copolymer latex was neutralized with addition of 20% liquor ammonia solution to pH of 9.3±0.5, under constant stirring using high speed disperser. The thickened latex was allowed to stabilize for 2 hours. The viscosity post thickening was checked using Brookfield RVT viscometer, and thick film of latex was cast using a steel applicator of 3000 microns. The film was dried for 7 days at ambient temperature. 1 square inch pieces were cut and dipped in water to determine water absorption. The readings were taken after 24 hours, 48 hours, 96 hours and 168 hours. The test was carried out in triplicate and average of three readings was considered. While taking the reading, the film was removed from water, excess water was removed through wiping by tissue paper; weighing of copolymer latex film was carried out using a balance with 1 mg least count. The results are mentioned in Table 2C.

TABLE 2C

| Parameters | Value |
|---|---|
| pH after thickening with liq. Ammonia | 9.4 |
| Thickening Viscosity in poise | 1560 |
| Clarity of the thick film after drying for 7 days | Clear |
| Clarity rating against clear transparent glass plate | 9 |
| [1 = poor (opaque) and 10 = best (transparent)] | |
| Water absorption, dipping - 24 hours (1 day) | 14.7% |
| Water absorption, dipping - 48 hours (2 days) | 25.9% |
| Water absorption, dipping - 96 hours (4 days) | 36.4% |
| Water absorption, dipping - 168 hours (7 days) | 43.6% |

### Example 2a: Modification of Example 2 (PRKB-095, Conventional Surfactant System) by Removing Acid Monomer(s)

The batch was processed as per Example 2 but without addition of any acid monomer. The batch showed no self-thickening behaviour at alkaline pH-initial viscosity 8 poise at pH=5.4 and viscosity at 9.2 pH=14 poise thereby demonstrating essentiality of organic acid component in the copolymer latex to achieve self-thickening property as in accordance with the embodiments of the present disclosure.

### Example 3: Preparation of a Copolymer Latex with Reactive Surfactant [Ref. No. PRKB-093]

Procedure: To 150 g of demineralized water, 35 g of external acrylic co-polymer seed latex was added in a reactor. 2 g of sodium bicarbonate was dissolved in 50 g of demineralized water and added to the reactor. The contents were heated to 88° C. Then 30 g of 4% solution of potassium persulphate in demineralized water was added to reactor. Further, the following two feeds were added to the reactor: 1) Monomer mix pre-emulsion as mentioned in Table 3A and 2) 100 g of 4% solution of potassium persulphate in demineralized water.

TABLE 3A

| Ingredient | Weight in grams |
|---|---|
| Demineralized water | 310 |
| Anionic reactive surfactant (20% active) | 48 |
| Non-ionic surfactant (70% active) | 3.5 |
| Butyl Acrylate | 586 |
| Methyl Methacrylate | 330 |
| Ethyl Acrylate | 146 |
| Styrene | 120 |
| Methacrylamide | 10 |
| Methacrylic Acid | 10 |
| Acrylic Acid | 10 |

At the end of feed of monomer mix pre-emulsion and initiator solution, the contents of the reactor were held at 88° C. for 1 hour, then partially cooled to 70° C. and then tertiary butyl hydroperoxide solution in demineralized water was added simultaneously with a solution of sodium metabisulphite in demineralized water for 1 hour. Then, the batch was held as such for about 1 hour. Further, the copolymer latex was cooled below 40° C. and a solution of preservative in demineralized water was added to the copolymer latex for in-can preservation. Then a dispersion of defoamer mixed with demineralized water is added to the copolymer latex for foam control.

The resulting copolymer latex has the following properties contained in Table 3B

TABLE 3B

| Parameters | Value | |
|---|---|---|
| Appearance | Milky white | |
| Total Solid Content (w/w) | 62.4% | |
| pH (as such) | 5.1 | |
| Viscosity in poise | 10 | |
| (Brookfield RVT viscometer, 20 RPM, 30° C.) | | |
| Clarity of dried film on glass plate, cast using steel | Clear | |
| applicator of 150 microns | | |
| Avg. Particle Size (diameter) | 268 | nm |
| Molecular Weight of the Polymer (Mw) | 149,883 | |
| Glass Transition Temperature (Tg), DSC | 12° | C. |
| % Free monomer (GC) | 0.07% | |
| Contact Angle | 69.46° | |
| Foam Height at t = 0 minutes | 10 | ml |
| Foam Height at t = 5 minutes | 8 | ml |

| | |
|---|---|
| Acc stability test, oven (55° C./15 days) | Stable, No |
| | separation/ |
| | syneresis |

The resulting copolymer latex showed self-thickening ability. 500 g of copolymer latex was neutralized with addition of 20% liquor ammonia solution to pH of 9.3±0.5, under constant stirring using high speed disperser. The thickened latex was allowed to stabilize for 2 hours. The viscosity post thickening was checked using Brookfield RVT viscometer, and thick film of latex was cast using a steel applicator of 3000 microns. The film was dried for 7 days at ambient temperature. 1 square inch pieces were cut and dipped in water to determine water absorption. The readings were taken after 24 hours, 48 hours, 96 hours and 168 hours. The test was carried out in triplicate and average of three readings was considered. While taking the reading, the film was removed from water, excess water was removed through wiping by tissue paper; weighing of copolymer latex film was carried out using a balance with 1 mg least count. The results are mentioned in Table 3C.

TABLE 3C

| Parameters | Value |
|---|---|
| pH after thickening with liq. Ammonia | 9.4 |
| Thickening Viscosity in poise | 1840 |
| Clarity of the thick film after drying for 7 days | Clear |
| Clarity rating against clear transparent glass plate | 9 |
| [1 = poor (opaque) and 10 = best (transparent)] | |
| Water absorption, dipping - 24 hours (1 day) | 9.6% |
| Water absorption, dipping - 48 hours (2 days) | 13.8% |
| Water absorption, dipping - 96 hours (4 days) | 21.7% |
| Water absorption, dipping - 168 hours (7 days) | 28.7% |

### Example 4(a): Preparation of a Copolymer Latex with Reactive Surfactant [Ref. No. PRKB-092]: Procedure

To 150 g of demineralized water, 35 g of external acrylic co-polymer seed latex was added in a reactor. 2 g of sodium bicarbonate was dissolved in 50 g of demineralized water and added to the reactor. The contents were heated to 88° C. Then 30 g of 4% solution of potassium persulphate in demineralized water was added to reactor.

Monomer mix pre-emulsion as mentioned in Table 4A1 was added in 2.5 hours followed by Monomer mix pre-emulsion as mentioned in Table 4A2. Second separate and simultaneous feed of 100 g of 4% solution of Potassium Persulphate in demineralized water was added.

TABLE 4A1

| Ingredient | Weight in grams |
|---|---|
| Demineralized water | 210 |
| Anionic reactive surfactant (20% active) | 32 |
| Non-ionic surfactant (70% active) | 2.35 |
| Butyl Acrylate | 352 |
| Methyl Methacrylate | 158 |
| Ethyl Acrylate | 146 |
| Styrene | 120 |
| Methacrylamide | 10 |
| Methacrylic Acid | 10 |
| Acrylic Acid | 10 |

TABLE 4A2

| Ingredient | Weight in grams |
|---|---|
| Demineralized water | 100 |
| Anionic reactive surfactant (20% active) | 16 |
| Non-ionic surfactant (70% active) | 1.15 |
| Butyl Acrylate | 234 |
| Methyl Methacrylate | 172 |

At the end of feed of monomer mix pre-emulsion and initiator solution, the contents of the reactor were held at 88° C. for 1 hour, then cooled to 70° C. and then tertiary butyl hydroperoxide solution in demineralized water was added simultaneously with a solution of sodium metabisulphite in demineralized water for 1 hour. Then the batch was held as such for about 1 hour. Further, the copolymer latex was cooled below 40° C. and a solution of preservative in demineralized water was added to the copolymer latex for in-can preservation. Then a dispersion of defoamer mixed with demineralized water is added to the copolymer latex for foam control.

The resulting copolymer latex has the following properties contained in Table 4B.

TABLE 4B

| Parameters | Value | |
|---|---|---|
| Appearance | Milky white | |
| Total Solid Content (w/w) | 62.4% | |
| pH (as such) | 5.2 | |
| Viscosity in poise | 8 | |
| (Brookfield RVT viscometer, 20 RPM, 30° C.) | | |
| Clarity dried film on glass plate, cast using steel | Clear | |
| applicator of 150 microns | | |
| Avg. Particle Size (diameter) | 314 | nm |
| Molecular Weight of the Polymer (Mw) | 200,644 | |
| Glass Transition Temperature (Tg), DSC | 10° | C. |
| % Free monomer (GC) | 0.06% | |
| Contact Angle | 71.08° | |
| Foam Height at t = 0 minutes | 15 | ml |
| Foam Height at t = 5 minutes | 8 | ml |

| | |
|---|---|
| Acc stability test, oven (55° C./15 days) | Stable, No |
| | separation/ |
| | syneresis |

The resulting copolymer latex showed self-thickening ability. 500 g of copolymer latex was neutralized with addition of 20% liquor ammonia solution to pH of 9.3±0.5, under constant stirring using high speed disperser. The thickened latex was allowed to stabilize for 2 hours. The viscosity post thickening was checked using Brookfield RVT viscometer, and thick film of latex was cast using a steel applicator of 3000 microns. The film was dried for 7 days at ambient temperature. 1 square inch pieces were cut and dipped in water to determine water absorption. The readings were taken after 24 hours, 48 hours, 96 hours and 168 hours. The test was carried out in triplicate and average of three readings was considered. While taking the reading, the film was removed from water, excess water was removed through wiping by tissue paper; weighing of copolymer latex film was carried out using a balance with 1 mg least count. The results are mentioned in Table 4C.

TABLE 4C

| Parameters | Value |
|---|---|
| pH after thickening with liq. Ammonia | 9.5 |
| Thickening Viscosity in poise | 1920 |
| Clarity of the thick film after drying for 7 days | Clear |
| Clarity rating against clear transparent glass plate | 9 |
| [1 = poor (opaque) and 10 = best (transparent)] | |
| Water absorption, dipping - 24 hours (1 day) | 7.75% |
| Water absorption, dipping - 48 hours (2 days) | 11.1% |
| Water absorption, dipping - 96 hours (4 days) | 13.5% |
| Water absorption, dipping - 168 hours (7 days) | 20.4% |

### Example 4(b): Modification-1 of Example 4 (PRKB-092, Reactive Surfactant System) by Removing Acid Monomer(s)

The batch was processed as per example 4 but without any acid monomer. The batch showed no self-thickening behaviour at alkaline pH-initial viscosity 10 poise at pH=5.5 and viscosity at 9.3 pH=12 poise demonstrating essentiality of organic acid component in the copolymer latex to achieve self-thickening property as in accordance with the embodiments of the present disclosure.

### Example 4(c): Modification-2 of Example 4 (PRKB-092, Reactive Surfactant System) by Increasing % Solid Content to 65%

The batch was processed as per Example 4 but with reduced water so that higher % solid content can be obtained. The batch resulted in 65% solid content with 10 poise viscosity at 4.9 pH. Further, at alkaline pH of 9.4, viscosity of 1850 poise was obtained and by the water dipping test mentioned above, water absorption after 24 hours was 7%.

### Example 4(d): Modification-3 of Example 4 (PRKB-092, Reactive Surfactant System) by Increasing % Solid Content to 70%

The batch was processed as per example 4 but with reduced water so that higher % solid content can be obtained. The batch resulted in 70% solid content with 29 poise viscosity at 4.2 pH. Further, at alkaline pH of 9.5, viscosity of 1940 poise was obtained and by the water dipping test mentioned above, water absorption after 24 hours was 6.8%.

### Example 4(e): Modification-4 of Example 4 (PRKB-092, Reactive Surfactant System) by Varying pH and effect on viscosity

To assess the effect of variation in pH on the viscosity of the copolymer latex formed by keeping other parameters same as Example 4(a), the observations are provided in the table 4D below. It is observed that the self-thickening efficiency between pH 6 to 12 varies from 20 to 2000 poise. Specifically, it is observed that the self-thickening efficiency of the copolymer latex composition in terms of viscosity rise is 1500-2000 poise at alkaline pH of 8.8 to 10.2 and more specifically between 8.8 to 9.8.

TABLE 4D

| | | | | | | | | | |
|---|---|---|---|---|---|---|---|---|---|
| pH* | 6.2 | 7.7 | 8.5 | 9.2 | 9.5 | 9.8 | 10.2 | 11.0 | 12.0 |
| Viscosity* | 20 | 100 | 650 | 1850 | 1920 | 1880 | 1600 | 1300 | 700 |

pH* = variation in pH;
Viscosity* = viscosity in poise

### Example 5: Preparation of a Copolymer Latex with Reactive Surfactant [Ref. No. PRKB-097] & 2-EHA

Procedure: To 150 g of demineralized water, 35 g of external acrylic co-polymer seed latex was added in a reactor. 2 g of sodium bicarbonate was dissolved in 50 g of demineralized water and added to the reactor. The contents were heated to 88° C. Then 30 g of 4% solution of potassium persulphate in demineralized water was added to reactor. Monomer mix pre-emulsion as mentioned in Table 5A1 was added in 2.5 hours followed by Monomer mix pre-emulsion as mentioned in Table 5A2. Second separate and simultaneous feed of 100 g of 4% solution of Potassium Persulphate in demineralized water was added.

TABLE 5A1

| Ingredient | Weight in grams |
|---|---|
| Demineralized water | 210 |
| Anionic reactive surfactant (20% active) | 32 |
| Non-ionic surfactant (70% active) | 2.35 |
| 2-Ethyl Hexyl Acrylate | 352 |
| Methyl Methacrylate | 158 |
| Ethyl Acrylate | 146 |
| Styrene | 120 |
| Methacrylamide | 10 |
| Methacrylic Acid | 10 |
| Acrylic Acid | 10 |

TABLE 5A2

| Ingredient | Weight in grams |
|---|---|
| Demineralized water | 100 |
| Anionic reactive surfactant (20% active) | 16 |
| Non-ionic surfactant (70% active) | 1.15 |
| 2-Ethyl Hexyl Acrylate | 234 |
| Methyl Methacrylate | 172 |

At the end of feed of monomer mix pre-emulsion and initiator solution, the contents of the reactor were held at 88° C. for 1 hour, then cooled to 70° C. and then Tertiary Butyl Hydroperoxide solution in demineralized water was added simultaneously with a solution of sodium metabisulphite in demineralized water for 1 hour. Then, the batch was held as such for about 1 hour. Further, the copolymer latex was cooled below 40° C. and a solution of preservative in demineralized water was added to the copolymer latex for in-can preservation. Then a dispersion of defoamer mixed with demineralized water is added to the copolymer latex for foam control. 10

The resulting copolymer latex has the following properties contained in Table 5B.

TABLE 5B

| Parameters | Value | |
|---|---|---|
| Appearance | Milky white | |
| Total Solid Content (w/w) | 62.3% | |
| pH (as such) | 5.1 | |
| Viscosity in poise | 15 | |
| (Brookfield RVT viscometer, 20 RPM, 30° C.) | | |
| Clarity of dried film on glass plate, cast using steel | Clear | |
| applicator of 150 microns | | |
| Avg. Particle Size (diameter) | 272 | nm |
| Molecular Weight of the Polymer (Mw) | 197,398 | |
| Glass Transition Temperature (Tg), DSC | 11° | C. |
| % Free monomer (GC) | 0.01% | |
| Contact Angle | 76.92° | |
| Foam Height at t = 0 minutes | 15 | ml |
| Foam Height at t = 5 minutes | 10 | ml |

| | |
|---|---|
| Acc stability test, oven (55° C./15 days) | Stable, No |
| | separation/ |
| | syneresis |

The resulting copolymer latex showed self-thickening ability. 500 g of copolymer latex was neutralized with addition of 20% liquor ammonia solution to pH of 9.3±0.5, under constant stirring using high speed disperser. The thickened latex was allowed to stabilize for 2 hours. The viscosity post thickening was checked using Brookfield RVT viscometer, and thick film of latex was cast using a steel applicator of 3000 microns. The film was dried for 7 days at ambient temperature. 1 square inch pieces were cut and dipped in water to determine water absorption. The readings were taken after 24 hours, 48 hours, 96 hours and 168 hours. The test was carried out in triplicate and average of three readings was considered. While taking the reading, the film was removed from water, excess water was removed through wiping by tissue paper; weighing of copolymer latex film was carried out using a balance with 1 mg least count. The results are mentioned in Table 5C.

TABLE 5C

| Parameters | Value |
|---|---|
| pH after thickening with liq. Ammonia | 9.7 |
| Thickening viscosity in poise | 1960 |
| Clarity of the thick film after drying for 7 days | Clear |
| Clarity rating against clear transparent glass plate | 9 |
| [1 = poor (opaque) and 10 = best (transparent)] | |
| Water absorption, dipping - 24 hours (1 day) | 5.4% |
| Water absorption, dipping - 48 hours (2 days) | 7.1% |
| Water absorption, dipping - 96 hours (4 days) | 10.7% |
| Water absorption, dipping - 168 hours (7 days) | 14.3% |

Referring to FIG. 5, 6, 7, 8 in one embodiment, the said copolymer latex provides water absorption by dipping the copolymer latex film in water for 24 hours, 48 hours, 96 hours, 168 hours in the range of 2.7% to 8.75%. This test suggests that the copolymer latex is water repellent or hydrophobic. Referring to FIG. 1, a hydrophobicity correlation is carried out using contact angle determination is disclosed.

### Example 6: Contact Angle Determination to Study Hydrophobicity of Each Composition in Example 1-5

TABLE 6

| | Batch | Contact | |
|---|---|---|---|
| Example | Number | angle | Remarks |
| 1 | PRKB 094 | 50.30° | with conventional surfactant |
| 2 | PRKB 095 | 53.98° | with conventional surfactant |
| 3 | PRKB 093 | 69.46° | with reactive surfactant |
| 4 | PRKB 092 | 71.08° | with reactive surfactant, with BA, |
| | | | Styrene 10% in pre-emulsion |
| | | | 1(PE1) |
| 5 | PRKB 097 | 76.92° | PRKB-092 with 2-EHA replacing |
| | | | BA completely |

Referring to FIG. 1, the hydrophobicity correlation is carried out using contact angle determination. The copolymer latex where the reactive surfactant is used, in polymerization with functional hydrophilic monomers such as organic acids and amides in the first stage (PRKB-097) shows maximum hydrophobicity (see Table 6).

### Example 7: Foaming Test to Study the Foaming Generated by Surfactants

10 ml copolymer latex & 40 ml De-mineralized water are taken in a measuring cylinder. 20 up-side-down shakes are given and then foam height is measured immediately (t=0) and after 5 minutes (t=5).

$$Before shaking initial height of the copolymer latex + DM water = 50 ml .$$

TABLE 7

| | Batch Number | | | | | | | |
|---|---|---|---|---|---|---|---|---|
| | 094 | | 095 | 093 | | 092 | | 097 |
| Foam height at t = 0 min | >50 | ml | 50 ml | 10 | ml | 15 | ml | 15 ml |
| Foam height at t = 5 min | 50 | ml | 45 ml | 8 | ml | 8 | ml | 10 ml |

Referring to FIGS. 2, 3, 4 foaming test results may be evaluated. The copolymer latexes where the reactive surfactant is used (PRKB-093,-PRKB-092 and PRKB-097) are showing least foaming after shaking.

### Example 8: Thickening pH and Viscosity Test Correlation

TABLE 8

| | | | | Thickening | |
|---|---|---|---|---|---|
| Batch | | | Thickening | viscosity | |
| Number | pH | Viscosity | pH | (Poise) | Remarks |
| PRKB | 5.5 | 180 | 9.6 | 1600 | with conventional |
| 094 | | | | | surfactant |
| PRKB | 5.5 | 6 | 9.4 | 1560 | with conventional |
| 095 | | | | | surfactant |
| PRKB | 5.1 | 10 | 9.4 | 1840 | with reactive |
| 093 | | | | | surfactant |
| PRKB | 5.2 | 8 | 9.5 | 1920 | with reactive |
| 092 | | | | | surfactant, with |
| | | | | | BA, Styrene 10% |
| | | | | | in PE1 |
| PRKB | 5.1 | 15 | 9.7 | 1960 | PRKB-092 with |
| 097 | | | | | 2-EHA replacing |
| | | | | | BA completely |

The composition has self-thickening efficiency which is denoted by the rise in viscosity of more than 1500 and upto 2000 poise at alkaline pH 8.8 to 9.8 using reactive surfactant.

### Example 9: Evaluation of Developed Copolymer Latexes in Transparent Sealant Guideline Formulation

| Ingredient | Weight (g) | Remarks |
|---|---|---|
| Polymer latex | 279.00 | Binder |

Add slowly under high-speed stirring,
a solution of wetting agent in water

| | |
|---|---|
| Wetting agent | 0.60 |
| De-mineralized water | 1.80 |

Mix for about 10 minutes and then add
under stirring a solution of Coalescing
agent in D M water

| | |
|---|---|
| Coalescing agent | 3.00 |
| De-mineralized water | 3.00 |

Mix for about 10 minutes and then add
under stirring a solution of Silane coupling
agent in De-mineralized water

| | |
|---|---|
| Silane coupling agent | 0.90 |
| De-mineralized water | 1.50 |

Mix for about 10 minutes and then add
under stirring Anti-sag agent as fumed
Silica

| | |
|---|---|
| Fumed Silica | 6.00 |

Mix about 10 minutes and then add Liquor Ammonia

| | | |
|---|---|---|
| Liquor Ammonia (20%) | 3.60 | Neutralizer |

Mix well for about 10 minutes and then add Rheolate 278

| | |
|---|---|
| Rheolate 278 | 0.60 |
| TOTAL | 300.00 |

Mix well for 10 minutes and the filter
the sealant through 40 mesh nylon cloth
and then fill in the cartridge.

The performance evaluation of sealants prepared as per Example 9 are represented in the below examples.

### Example 10: Evaluation of Physical Properties

| | | | PRKB- | PRKB- | PRKB- | PRKB- | PRKB- |
|---|---|---|---|---|---|---|---|
| | | | 094 | 095 | 093 | 092 | 097 |
| | Physical | Test | Example | Example | Example | Example | Example |
| # | Properties | Method | no. 1 | no. 2 | no. 3 | no. 4 | no. 5 |
| 1 | Physical | Visual | White homogenous paste | | | | |
| | appearance | observation | | | | | |
| 2 | % Solid Content @ | — | 61.1 | 60.3 | 60.4 | 61.0 | 60.2 |
| | 105° C./1.5 hours | | | | | | |
| 3 | Density (g/ml) | ASTM D | 0.95 | 0.96 | 0.95 | 0.97 | 0.95 |
| | | 1475 | | | | | |
| 4 | pH of sealant | pH meter | 9.16 | 9.2 | 9.1 | 9.30 | 9 |
| 5 | Viscosity by | Viscometer | 275 | 250 | 300 | 310 | 290 |
| | Penetrometer | | | | | | |
| | (Depth of | | | | | | |
| | Penetration (DOP)) | | | | | | |

### Example 11

Property evaluation of sealant prepared as per Example 9 by incorporating copolymer latex compositions of Examples 1 to 5

| | | | PRKB- | PRKB- | PRKB- | PRKB- | PRKB- |
|---|---|---|---|---|---|---|---|
| | | | 094 | 095 | 093 | 092 | 097 |
| | Physical | Test | Example | Example | Example | Example | Example |
| # | Properties | method | 1 | 2 | 3 | 4 | 5 |
| 1 | Appearance after cure | — | Transparent | Transparent | Transparent | Transparent | Transparent |
| 2 | Tensile strength, N/mm² | ASTM | 0.98 | 1.12 | 1.10 | 1.18 | 1.28 |
| | (MPa) [Avg. of 5 | D 412 | | | | | |
| | readings] | | | | | | |
| 3 | Elongation at break, % | ASTM | 822 | 796 | 843 | 835 | 825 |
| | [Avg. of 5 readings] | D 412 | | | | | |
| 4 | Water absorption | — | 9.35 | 7.50 | 5.20 | 4.25 | 2.7 |
| | (Immersed in water for 24 | | | | | | |
| | hours), % 1 day | | | | | | |
| 5 | Water absorption | — | 18.50 | 14.36 | 8.28 | 6.13 | 4.57 |
| | (Immersed in water for 48 | | | | | | |
| | hours), % 2 days | | | | | | |
| 6 | Water absorption | — | 24.80 | 21.10 | 13.62 | 8.90 | 6.65 |
| | (Immersed in water for 96 | | | | | | |
| | hours), % 4 days | | | | | | |
| 7 | Water absorption | — | 30.50 | 26.80 | 17.10 | 12.30 | 8.75 |
| | (Immersed in water for | | | | | | |
| | 168 hours), % 7 days | | | | | | |

Referring to Example 10 and 11 it may be observed that the sealant formulation based on the invented copolymer latex provides evaluation of tensile strength, water absorption, and elongation at break properties.

The said copolymer latex composition has balanced tensile strength and elongation, which are important parameters for performance of any sealant. These are critical requirements for the final performance of the sealant.

### Example 12: Evaluation by Peel Off Adhesion Test in Dry and Wet Conditions

To study the adhesive characteristic of the said copolymer latex peel off adhesion test was carried out on variety of substrates as shown in Table 9. The composition has good adhesion characteristic which is denoted by the peel off adhesion test rating in the examples PRKB-092 and PRKB-097.

TABLE 9

| | PRKB- | PRKB- | PRKB- | PRKB- | PRKB- |
|---|---|---|---|---|---|
| Substrate | 094 | 095 | 093 | 092 | 097 |

Peel off Adhesion on Dry Condition
(By Hand) *, Rating: 0 = Worst & 10 =
Best

| | | | | | |
|---|---|---|---|---|---|
| Wood (Painted) | 4-5 | 4-5 | 5-6 | 7-8 | 7-8 |
| Anodized Aluminum | 6-7 | 6-7 | 7-8 | 7-8 | 7-8 |
| Marble | 6-7 | 6-7 | 7-8 | 7-8 | 7-8 |
| Granite | 5-6 | 6-7 | 6-7 | 6-7 | 7-8 |
| Glazed Tile | 5-6 | 5-6 | 5-6 | 6-7 | 7-8 |

Peel off Adhesion on Wet Condition
(By Hand) *, Rating: 0 = Worst & 10 =
Best

| | | | | | |
|---|---|---|---|---|---|
| Wood (Painted) | 2-3 | 2-3 | 3-4 | 4-5 | 4-5 |
| Anodized Aluminum | 3-4 | 3-4 | 4-5 | 5-6 | 6-7 |
| Marble | 3-4 | 3-4 | 4-5 | 5-6 | 5-6 |
| Granite | 2-3 | 3-4 | 4-5 | 5-6 | 5-6 |
| Glazed Tile | 2-3 | 3-4 | 3-4 | 5-6 | 5-6 |

The foregoing description shall be interpreted as illustrative and not in any limiting sense. A person of ordinary skill in the art would understand that certain modifications could come within the scope of this disclosure.

We claim:

1. A copolymer latex comprising:
at least 55% solids of polymerization product of one or more monomers of an acrylic monomer fraction, an organic acid fraction, an amide derivative fraction, and a surfactant fraction,
wherein the stated surfactant fraction is at least 0.4% based on total monomer quantity,
wherein viscosity of the copolymer latex composition is between 2 to 50 poise at an acidic pH, and self-thickening efficiency is in terms of viscosity rise is between 1500-2000 poise at an alkaline pH.

2. The copolymer latex as claimed in claim 1, further comprises vinyl monomer(s) including styrene.

3. The copolymer latex as claimed in claim 1, wherein the amide derivative is in a range of at least 0.1 to 5% based on total monomer quantity.

4. The copolymer latex as claimed in claim 1, wherein the organic acid fraction is in a range of at least 0.1 to 5 parts % based on total monomer quantity.

5. The copolymer latex as claimed in claim 1, wherein the acrylic monomer fraction is at least 75% based on total monomer quantity.

6. The copolymer latex as claimed in claim 1, comprises 55-71% solid content.

7. The copolymer latex as claimed in claim 1, wherein viscosity of the copolymer latex composition is between 2-50 poise at an acidic pH of 4.5 to 6.

8. The copolymer latex as claimed in claim 1, wherein self-thickening efficiency of the copolymer latex composition in terms of viscosity rise is 1500-2000 poise at alkaline pH of 8.8 to 9.8.

9. The copolymer latex as claimed in claim 1, wherein the organic acid fraction comprises of at least one of methacrylic acid, acrylic acid, or a combination.

10. The copolymer latex as claimed in claim 1, wherein the said surfactant fraction comprises of a reactive surfactant.

11. The copolymer latex composition as claimed in claim 10, wherein the reactive surfactant is selected from modified fatty alcohol ether phosphates, Polyoxyethylene (allyloxymethyl) alkyl ether sulphates or Polyoxyethylene styrenated propenyl phenyl ether sulphates, and alkyl allyl sulfosuccinates.

12. The copolymer latex as claimed in claim 1, wherein the amide derivative comprises of at least one of acrylamide, methacrylamide, or a combination.

13. The copolymer latex as claimed in claim 1, wherein the acrylate monomers comprise at least one of butyl acrylate, methyl methacrylate, ethyl acrylate, and 2-ethyl hexyl acrylate.

14. The copolymer latex as claimed in claim 1, wherein dry film thickness (DFT) of the copolymer latex composition, when casted, is about 1-3 mm.

15. The copolymer latex as claimed in claim 1, wherein clarity of dried thick film of about 2 mm of copolymer latex is transparent.

16. The copolymer latex as claimed in claim 1, wherein water absorption of the dry film of copolymer latex composition evaluated by water absorption test by dipping dry film of the copolymer latex in water for 24 hours is less than 10%, and for 96 hours is less than 15%.

17. The copolymer latex as claimed in claim 1, wherein particle size of the copolymer latex composition is in the range of 200 nm to 500 nm.

18. The copolymer latex composition as claimed in claim 1, wherein glass transition temperature (Tg) of the copolymer latex composition is in the range of −5 to 15° C.

19. A sealant composition comprising:
one or more additives selected from a wetting agent; a coalescing agent; a silane coupling agent; an anti-sag agent; a neutralizer; a rheology modifier; and
a copolymer latex composition,
characterized in that
the copolymer latex composition consisting of:
at least 55% solids of polymerization product of one or more monomers of acrylic monomer fraction, an organic acid fraction, an amide derivative, and a surfactant fraction,
wherein the stated surfactant fraction is at least 0.4% based on total monomer quantity,
wherein viscosity of the copolymer latex composition is between 5 to 30 poise at an acidic pH, and
wherein self-thickening efficiency of the copolymer latex composition in terms of viscosity rise is 1500-2000 poise at an alkaline pH.

20. The sealant composition as claimed in claim 19, wherein appearance of dried film of a non-pigmented sealant is transparent.
